(19) United States
(12) Patent Application Publication
(10) Pub. No.: US 2006/0002436 A1
(43) Pub. Date: Jan. 5, 2006

(54) Wavelength tunable laser and method of controlling the same

(75) Inventors: Kazumasa Takabayashi, Kawasaki (JP); Tadao Nakazawa, Zama (JP); Yumi Nakazawa, Zama (JP); Takashi Shiraishi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/023,985

(22) Filed: Dec. 29, 2004

(30) Foreign Application Priority Data
Jul. 1, 2004 (JP) 2004-195879

(51) Int. Cl. H01S 3/10

(52) U.S. Cl. 372/20; 372/98

(57) ABSTRACT

A wavelength tunable laser is constituted by including a resonator composed of a pair of reflectors arranged to face each other, and inside the resonator, a SOA radiating a laser beam with a gain for a wide range of wavelengths, a transmission-type wavelength tunable filter having an asymmetric filter characteristic, and a phase controller controlling a phase of the laser beam resonating inside the resonator.

### CROSS-REFERENCE TO RELATED APPLICATIONS

This application is based upon and claims the benefit of priority from the prior Japanese Patent Application No. 2004-195879, filed on Jul. 1, 2004, the entire contents of which are incorporated herein by reference.

### BACKGROUND OF THE INVENTION

1. Field of the Invention

The present invention relates to a wavelength tunable laser of which an oscillation wavelength is tunable and a method of controlling the same.

2. Description of the Related Art

Along with dramatic increase in demands for communication in recent years, development of multi-wavelength communication systems (wavelength division multiplexing (WDM) systems), which realize high-capacity transmission by a single optical fiber by way of multiplexing plural single beams of different wavelength, shows progress. For such a wavelength division multiplexing system, a wavelength tunable laser capable of selecting a desired wavelength from a wide range of wavelengths is strongly expected in building the systems.

FIGS. 11 and FIGS. 12 are schematic diagrams showing basic structures of a wavelength tunable laser using a conventional wavelength tunable filter, and FIG. 11A and FIG. 12A show wavelength tunable lasers using transmission-type wavelength tunable filters, and FIG. 11B and FIG. 12B show wavelength tunable lasers using reflection-type tunable wavelength filters, respectively.

The transmission-type wavelength tunable laser shown in FIG. 11A in which a resonator 111 is composed of a pair of reflectors 101, 102 arranged to face each other, includes, in the resonator 111, a semiconductor optical amplifier: SOA 103 radiating a laser beams with a gain for a wide range of wavelengths, a transmission-type wavelength tunable filter 104 allowing an oscillation wavelength to be tunable and capable of selecting a desired wavelength from a wide range of wavelengths, and a phase controller 105 controlling the phase of the laser beam resonating in the resonator 111.

On the other hand, a reflection-type wavelength tunable laser shown in FIG. 11B in which a resonator 112 is composed of a reflector 101 and a reflection-type wavelength tunable filter 106 arranged to face the reflector 101, includes, in the resonator 111, a SOA 103 and a phase controller 105.

In these wavelength tunable lasers, in order to achieve a laser oscillation at a desired wavelength, the following controls are required.

A first control is, as shown in FIG. 13A, a control such that a transmissive peak wavelength or a reflective peak wavelength of a tunable filter (hereinafter, it is simply designated as the peak wavelength) represented by a dotted line BL in the drawing is adjusted in the direction of, for example, an arrow A so that the peak wavelength is allowed to be a target wavelength λ₁ represented by a solid line SL in the drawing. A second control is, as shown in FIG. 13B, a control such that a longitudinal mode position of the resonators 111, 112 represented by a dotted line BL in the drawing is adjusted in the direction of, for example, an arrow B so that the longitudinal mode position practically coincides with the wavelength λ₁ represented by a solid line SL by means of the phase controller 105.

The transmission-type wavelength tunable laser shown in FIG. 12A is constituted with an etalon 107 as being an optical element having a cyclic transmissive wavelength added to the structure of the wavelength tunable laser in FIG. 11A. The reflection-type wavelength tunable laser shown in FIG. 12B is similarly constituted with an etalon 107 added to the structure of the wavelength tunable laser in FIG. 11B. The etalons 107 are arranged respectively, for example, between the phase controller 105 and the reflector 102 inside the resonator 111, or, for example, between the phase controller 105 and the wavelength tunable filter 106 inside the resonator 112.As shown in FIG. 14A, a semiconductor laser without filter has a possibility of oscillating at all wavelengths coinciding with the longitudinal modes of the resonator. Whereas, the above-described wavelength tunable laser can oscillate only at wavelengths in the longitudinal modes positioned in the vicinity of the cyclic transmissive wavelength of the etalon, as shown in FIG. 14B. In this case, as shown in FIG. 14C, the oscillation at the arbitrary transmissive wavelength of the etalon is possible by choosing one of the cyclic transmissive wavelengths of the etalon by the wavelength tunable filter.

In these wavelength tunable lasers, in order to achieve a laser oscillation at a desired wavelength, the following controls are required.

A first control is, as shown in FIG. 15A, a control such that a peak wavelength of a tunable filter represented by a dotted line BL in the drawing is adjusted in the direction of, for example, an arrow A so that the peak wavelength is allowed to be a transmissive wavelength of the etalon 107 λ₂ represented by a solid line SL in the drawing. A second control is, as shown in FIG. 15B, a control such that the longitudinal mode position of the resonators 111, 112 represented by a dotted line BL in the drawing is adjusted in the direction of, for example, an arrow B so that the longitudinal mode position practically coincides with the wavelength λ₂ represented by a-solid line SL in the drawing by means of the phase controller 105.

In the wavelength tunable laser shown in FIG. 11A and FIG. 11B, when the second control, namely, the control such that the longitudinal mode position is adjusted to the peak wavelength of the wavelength tunable filters 104, 106 is performed, a control method of, for example, feeding back an optical output power so as to be maximum by monitoring the output power can be considered. This utilizes the fact that a resonator loss in the wavelength tunable laser becomes minimum and the optical output power becomes maximum when oscillating at the peak wavelength of the wavelength tunable filters 104, 106.

In the wavelength tunable laser of FIGS. 12, the control method of feeding back so that the optical output power becomes maximum can be considered also in the case that the first control, namely the control such that the transmissive wavelength or the reflective wavelength of the wavelength tunable filters 104, 106 is adjusted to a desired transmissive wavelength of the etalon 107 is performed. In this case, the point where the optical output power becomes maximum is to be retrieved by moving the peak wavelength of the wavelength tunable filter. From the relative standpoint, this is similar to the case that the longitudinal mode position is moved with the wavelength of the wavelength filters 104, 106 fixed, in the second control of the wavelength tunable laser in FIGS. 11.

In general, it has been considered that a filter having a symmetric spectrum shape with respect to the peak wavelength as the wavelength tunable filter is desirable to perform a stable wavelength control in the wavelength tunable laser as described above. It is because a state of variation in the laser characteristic becomes same in the case that the oscillation wavelength shifts to the long wavelength side from the filter peak wavelength, as well as in the case that it shifts to the short wavelength side, as a result, a simple control can be performed.

[Patent Document 1] Japanese Patent Application Laid-Open No. 2000-261086

[Non-Patent Document 1] Kotaki, Y.;Ishikawa, H.;,IEEE Journal of Quantum Electronics volume:25, Issue: 6 Jun. 1989 Pages:1340-1345

However, in the case that the wavelength tunable filter having a symmetric spectrum shape with respect to the peak wavelength is used in the wavelength tunable laser of FIGS. 11, the state of variation in the laser characteristic, for example optical output power, is different between in the case that the oscillation wavelength shifts to the long wavelength side from the filter peak wavelength and in the case that it shifts to the short wavelength side. As shown in FIG. 16 indicating the relation of the longitudinal mode position and the optical output power, the variation of the optical output power is asymmetric against peak wavelength in which optical output power becomes maximum, and the peak wavelength approaches extremely the wavelength where the optical output power varies discontinuously at the short wavelength side. The discontinuity represents the unstable condition such that the oscillation wavelength hops to an adjacent longitudinal mode and the noise characteristic deteriorates. Therefore, the control should be performed, avoiding the discontinuity, however, the control avoiding the discontinuity is exceedingly difficult because a tolerance of control is narrow due to the approach of the discontinuity to the optical output power peak wavelength.

Similarly, in the wavelength tunable laser of FIGS. 12, when the first control, namely, the control in which the transmissive wavelength or the reflective wavelength of the wavelength tunable filters 104, 106 is adjusted to a desired transmissive wavelength of the etalon 107 is performed, there also exists unstable points where the optical output power are discoutinuous near the optical output power peak wavelength (in this case, the points where a wavelength hopping occurs between the transmissive wavelength of the etalon 107), therefore a stable control is difficult to be performed.

### SUMMARY OF THE INVENTION

This invention has been made in view of the above-described problems, and an object thereof is to provide a wavelength tunable laser and a method of controlling the same, capable of radiating a stable laser beam at a desired oscillation wavelength with a good noise characteristic.

A wavelength tunable laser of the present invention includes a resonator, an optical amplifier provided inside the resonator, radiating a laser beam, a wavelength tunable filter provided inside the resonator or as one part of the resonator, allowing an oscillation wavelength to be tunable, and a phase controller controlling a phase of the laser beam resonating inside the resonator, in which the wavelength tunable filter has an asymmetric filter characteristic and is designed so that a loss given to a long wavelength side with respect to a peak wavelength of the filter is larger than a loss given to a short wavelength side.

A method for controlling a wavelength tunable laser in the present invention is performed using the wavelength tunable laser including a resonator, an optical amplifier provided inside the resonator, radiating a laser beam, a wavelength tunable filter provided inside the resonator or as one part of the resonator, allowing an oscillation wavelength to be tunable, and a phase controller controlling a phase of the laser beam resonating inside the resonator, in which the wavelength tunable filter has an asymmetric filter characteristic and is designed so that a loss given to a long wavelength side with respect to the peak wavelength of the filter is larger than a loss given to a short wavelength side, so that the oscillation wavelength of the laser beam from the optical amplifier is allowed to coincide with the peak wavelength of the filter in the wavelength tunable filter.

### BRIEF DESCRIPTION OF THE DRAWINGS

FIGS. 1A and 1B are schematic diagrams showing basic structures of a wavelength tunable laser of the present invention;

FIGS. 2A and 2B are schematic diagrams showing basic structures of the wavelength tunable lasers of the present invention;

FIG. 3 is a characteristic chart explaining problems of a conventional wavelength tunable laser;

FIG. 4 is a characteristic chart showing a result of an experiment in which the optimum range of filter loss asymmetricity in the wavelength tunable laser in the present invention is examined;

FIGS. 5A to 5D are characteristic charts showing relations between longitudinal mode positions and optical output powers when using a conventional wavelength tunable filter having a symmetric filter characteristic with respect to a peak wavelength;

FIGS. 6A and 6B are characteristic charts showing the relations between wavelengths and the transmittance or the reflectance in a wavelength tunable filter of the present invention, based on the comparison with the conventional wavelength tunable filter;

FIGS. 7A to 7D are characteristic charts showing relation between the longitudinal mode positions and the optical output powers when using the wavelength tunable filter in the present invention having an asymmetric filter characteristic with respect to the peak wavelength;

FIGS. 8A and 8B are schematic diagrams showing a principal structure of a transmission-type wavelength tunable laser according to a first embodiment;

FIG. 9 is an explanatory chart showing an example realizing an asymmetric filter characteristic by an AOTF according to the first embodiment;

FIGS. 10A and 10B are schematic diagrams showing a principal structure of a reflection-type wavelength tunable laser according to a second embodiment;

FIGS. 11A and 11B are schematic diagrams showing basic structures of the conventional wavelength tunable lasers;

FIGS. 12A and 12B are schematic diagrams showing basic structures of the conventional wavelength tunable lasers;

FIGS. 13A and 13B are characteristic charts showing an oscillation control of the wavelength tunable laser in FIGS. 11;

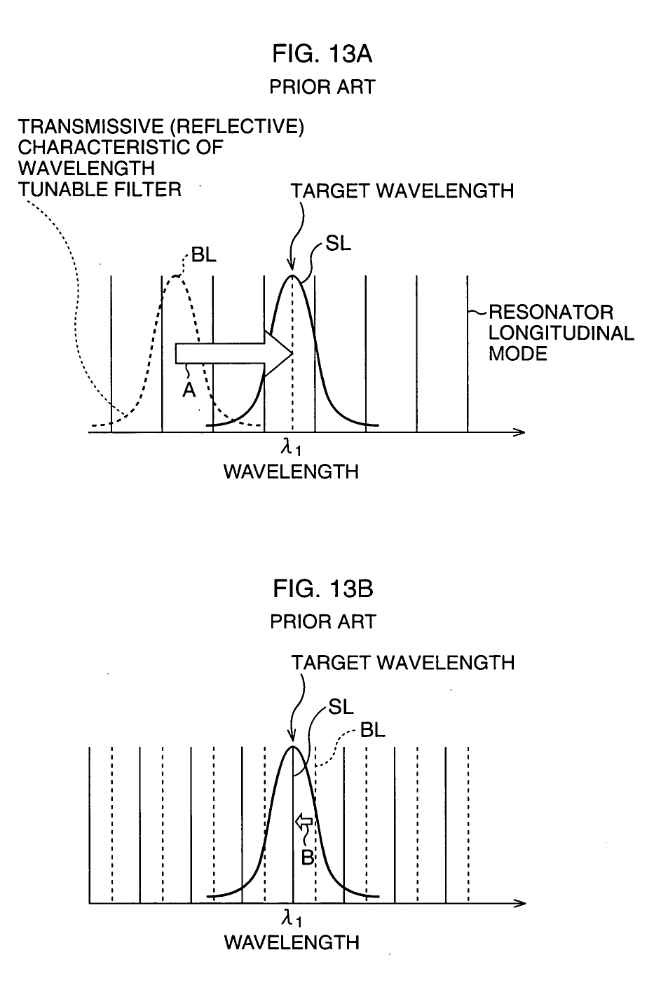

FIGS. 14A to 14C are characteristic charts showing an oscillation control of the wavelength tunable laser in FIGS. 12;

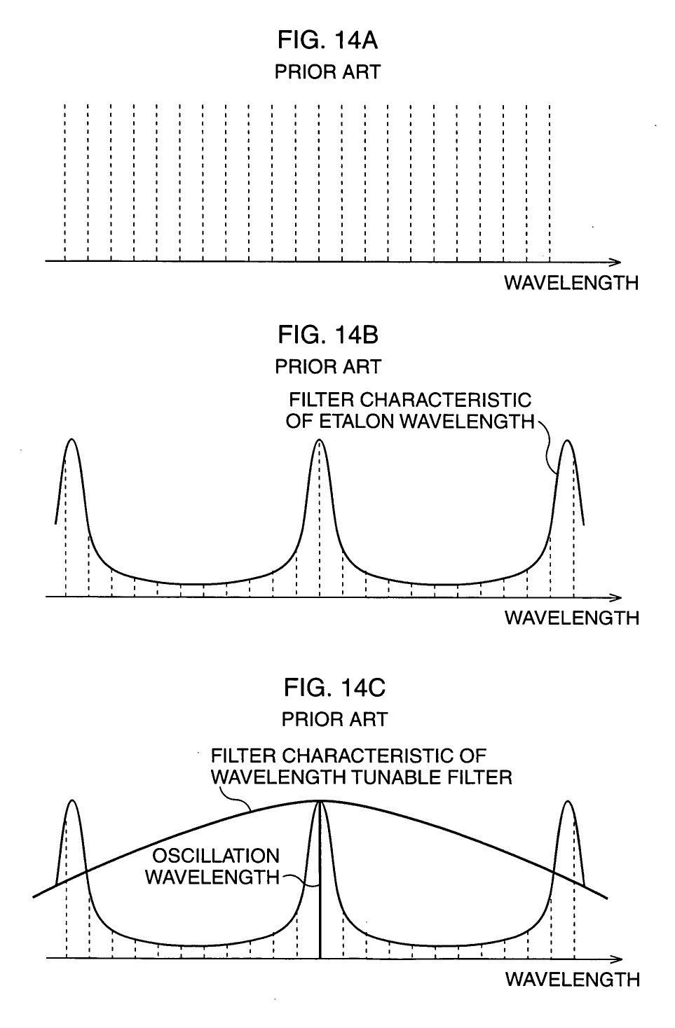

FIGS. 15A and 15B are characteristic charts showing an oscillation control of the wavelength tunable laser in FIGS. 12; and

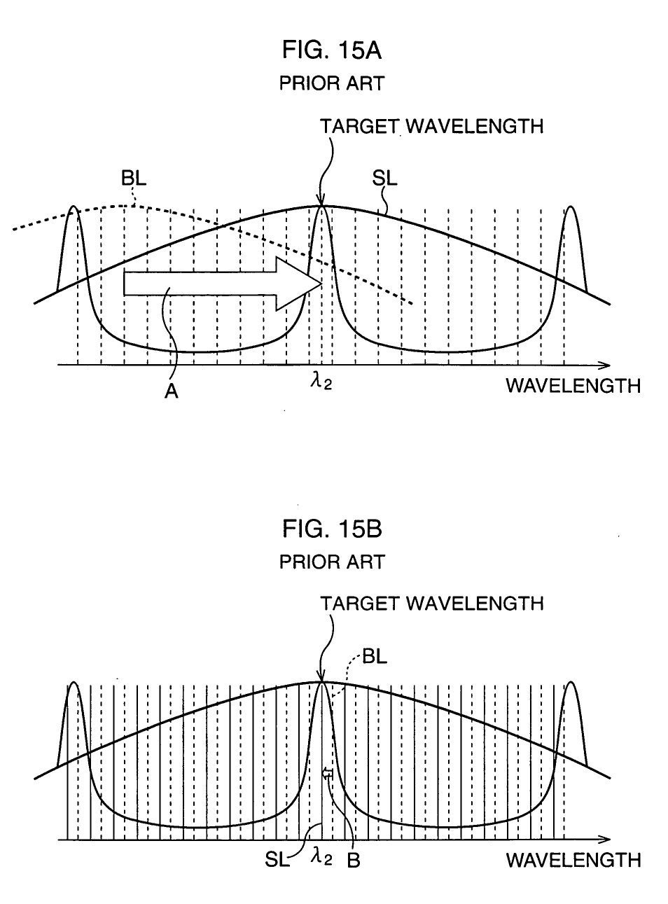

FIG. 16 is a characteristic chart showing a relation between longitudinal mode positions and optical output powers to explain problems when using the conventional wavelength tunable filter having the symmetric filter characteristic with respect to the peak wavelength.

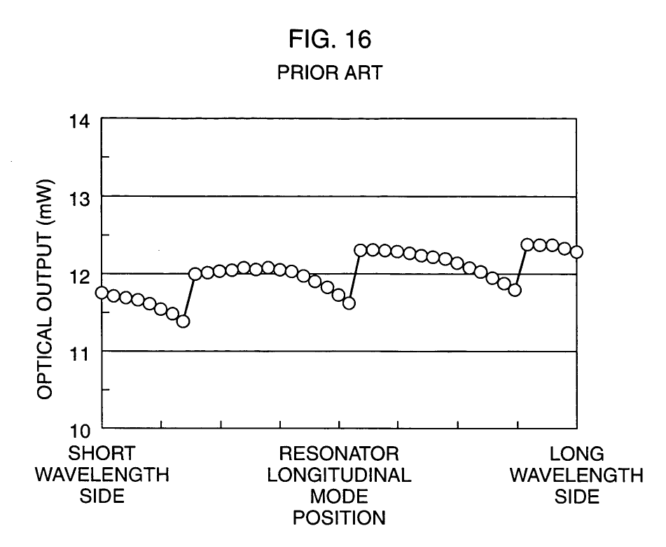

### DETAILED DESCRIPTION OF THE PREFERRED EMBODIMENTS

### BASIC GIEST OF PRESENT INVENTION

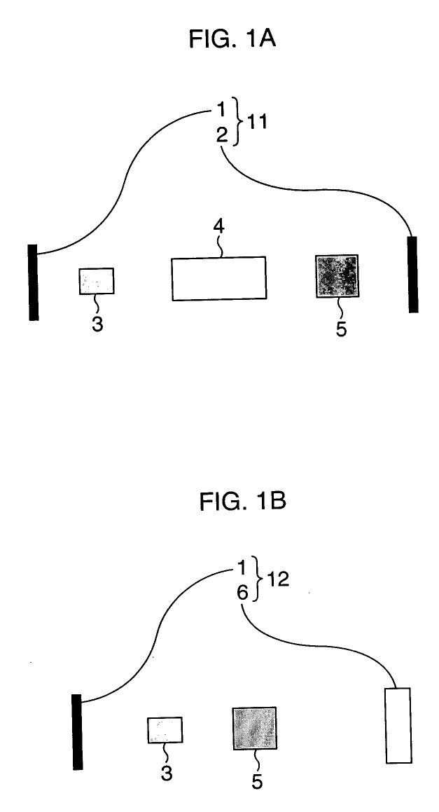

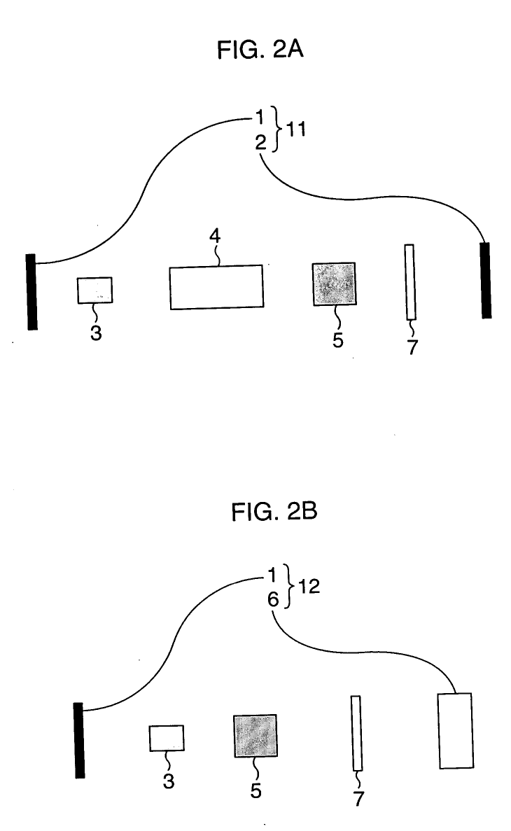

FIGS. 1 and FIGS. 2 are schematic diagrams showing basic structures of a wavelength tunable laser of the present invention. FIG. 1A and FIG. 2A show transmission-type wavelength tunable lasers and FIG. 1B and FIG. 2B show reflection-type wavelength tunable lasers respectively.

A transmission-type wavelength tunable laser shown in FIG. 1A in which a resonator 11 is composed of a pair of reflectors 1, 2 arranged to face each other includes, in the resonator 11, a semiconductor optical amplifier (SOA) 3 radiating a laser beam with a gain for a wide range of wavelengths, a transmission-type wavelength tunable filter 4 allowing an oscillation wavelength to be tunable and capable of selecting a desired wavelength from a wide range of wavelengths, and a phase controller 5 controlling a phase of the laser beam resonating in the resonator 11.

On the other hand, a reflection-type wavelength tunable laser shown in FIG. 1B in which a resonator 12 is composed of the reflector 1 and a reflection-type wavelength tunable filter 6 arranged to face the reflector 1 includes, in the resonator 12, the SOA 3 and the phase controller 5.

As shown in FIG. 2A, a structure such that an etalon 7 which is an optical element having a cyclic transmissive wavelength is added to the transmission-type wavelength tunable laser shown in FIG. 1, or a structure such that the etalon 7 is similarly added to the reflection-type wavelength tunable laser shown in FIG. 1B are also suitable.

In the present invention, filter characteristics of the wavelength tunable filters 4, 6 are asymmetric, in this case asymmetric between a short wavelength side and a long wavelength side with a peak wavelength as the center, and are designed so that losses given to the long wavelength side are larger than losses given to the short wavelength side. Specifically, the loss in a wavelength which is apart from the peak wavelength of the wavelength tunable filter to the long wavelength side by a half value of an oscillatable mode interval is from 0.5 dB to 10 dB larger than the loss in a wavelength which is apart to the short wavelength side by a half value of the occillatable longitudinal mode.

The operational principles of the wavelength tunable filters 4, 6 are now described as follows.

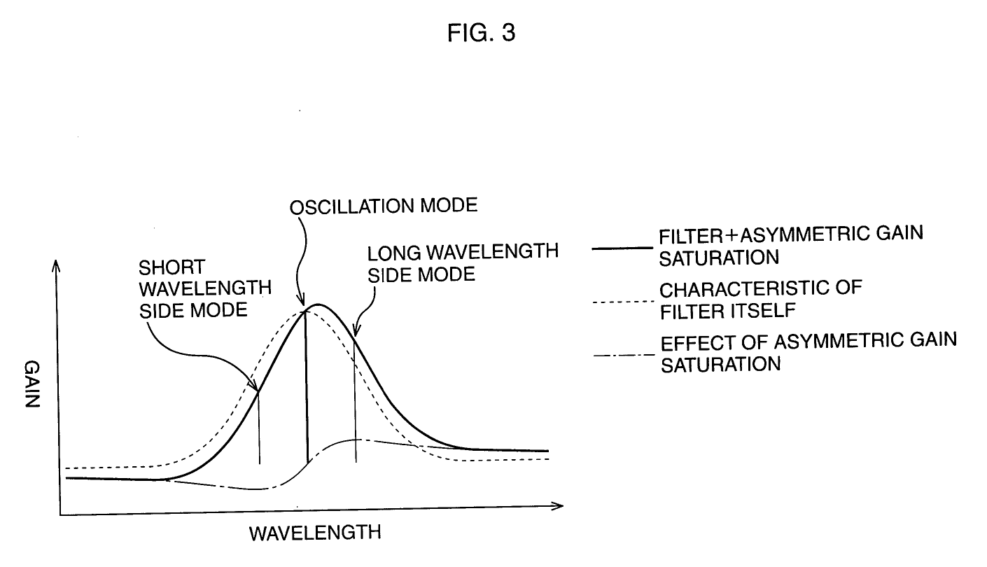

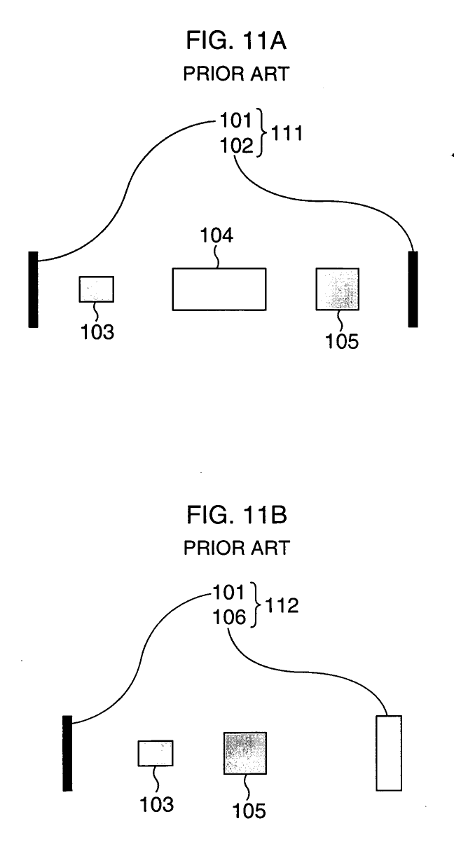

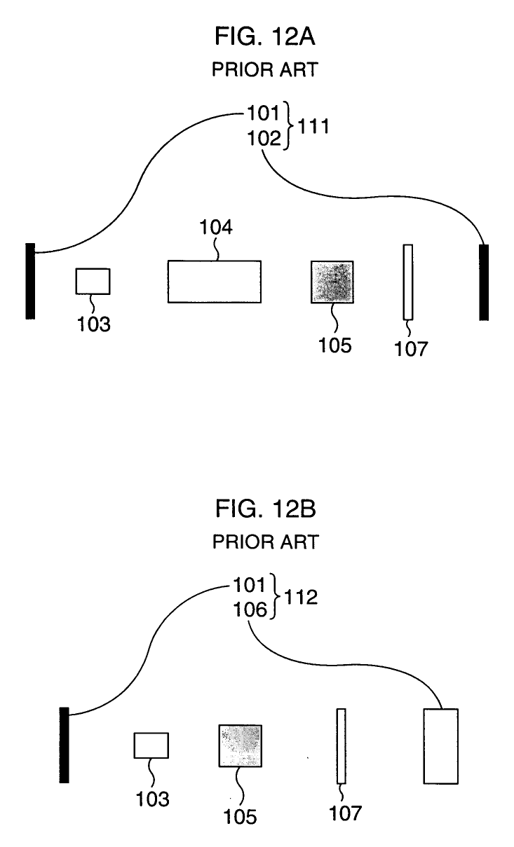

It is considered that the asymmetricity in a relation between an optical output power and a phase in the conventional wavelength tunable laser shown in FIGS. 11, or in a relation between the optical output power and the peak wavelength of the wavelength tunable filter when a symmetric wavelength tunable filter is used in the conventional wavelength tunable laser shown in FIGS. 12 is caused by so-called asymmetric gain saturation in the SOA. This is the phenomenon such that a gain in the long wavelength side of the oscillation wavelength is increased and a gain in the short wavelength side is decreased in the SOA when the laser oscillation is generated as shown in FIG. 3.

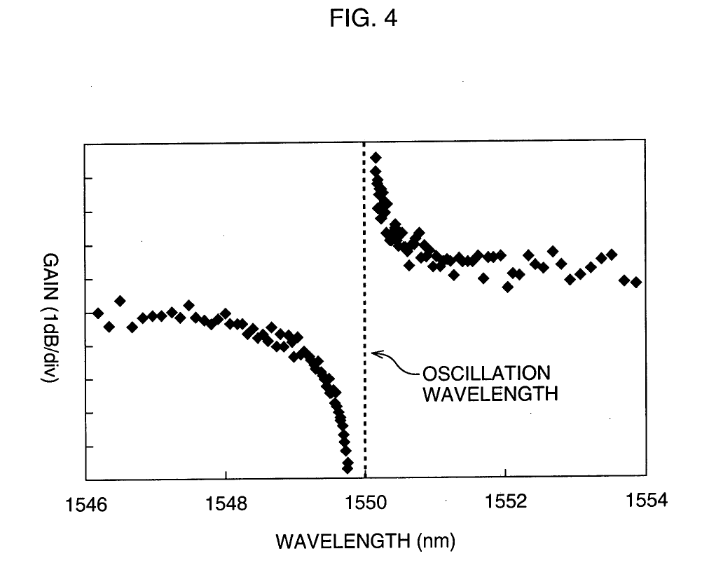

A difference between the loss in the wavelength which is apart from the peak wavelength to the long wavelength side by the a half value of an oscillatable longitudinal mode interval and the loss in the wavelength which is apart to the short wavelength side by the a half value varies in accordance with a structure of an active layer used for the SOA or a wavelength difference from the oscillation wavelength (mode interval) and the like. Suppose that the mode interval is in a range from 0.01 nm to 5 nm using the active layer of MQW, for example, it is proved from our experiment that the difference between the gain in the wavelength which is apart from the oscillation wavelength to the long wavelength side by the a half value of an oscillatable longitudinal mode interval and the loss in the wavelength which is apart to the short wavelength side by the a half value is approximately 0.5 dB to 10 dB. The experimental result thereof is shown in FIG. 4. Here, a left side of the oscillation wavelength shown by a dotted line in the drawing is the short wavelength side, and a right side thereof is the long wavelength side, and it is found out that the difference between these sides is approximately at a maximum of 10 dB and at a minimum of 0.5 dB.

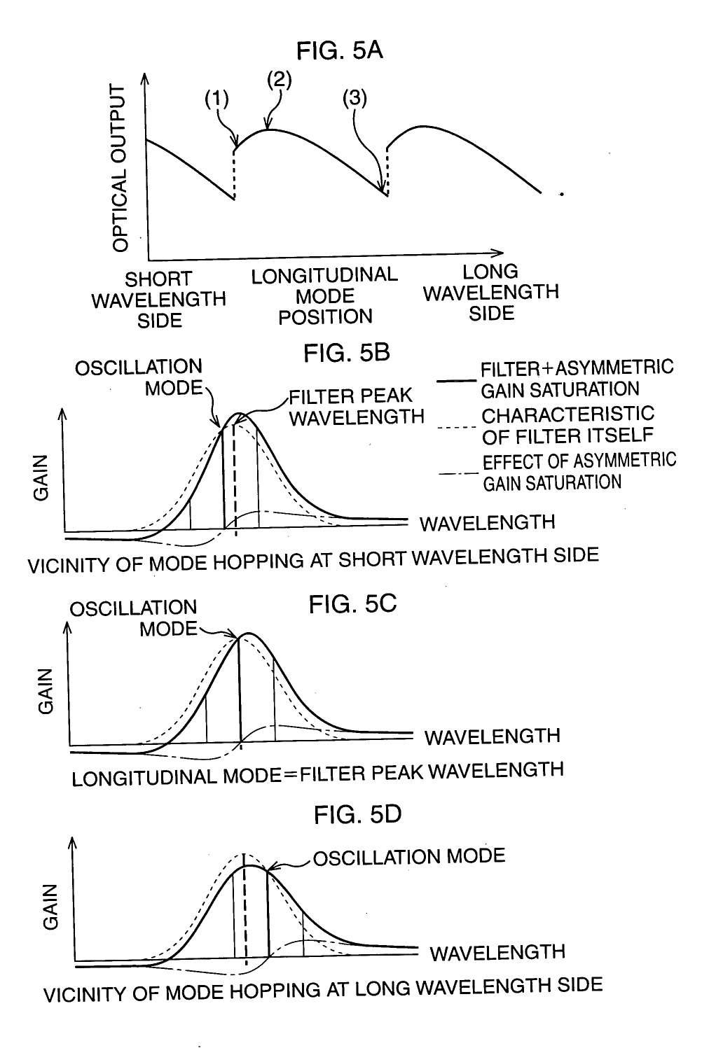

FIGS. 5 are characteristic charts showing relations between longitudinal mode positions and optical output powers when the conventional wavelength tunable filter having a symmetric filter characteristic with respect to the peak wavelength is used.

FIG. 5A is a characteristic chart showing a relation between the longitudinal mode positions and the optical output powers, FIG. 5B is a characteristic chart showing a relation between a wavelength and a gain shown in numeral (1) of FIG. 5A, in the vicinity of a point where the optical output power varies discontinuously and a mode hopping occurs (discontinuity) in the shorter wavelength than peak wavelength of the filter, FIG. 5C is a characteristic chart showing a relation between a wavelength and a gain when the longitudinal mode shown in numeral (2) of FIG. 5A, in the vicinity of a point where the longitudinal mode position coincides with the peak wavelength of the filter , and FIG. 5D is a characteristic chart showing a relation between a wavelength and a gain shown in numeral (3) of FIG. 5A, at the vicinity of the discontinuity in the longer wavelength then peak wavelength of the filter.

As shown in FIG. 5A, when a wavelength tunable filter having a symmetric filter characteristic with respect to the peak wavelength is used, the discontinuity i.e., the point where the gain of the oscillation mode becomes equivalent to the gain of the adjacent longitudinal mode shifts to the long wavelength side from the point where the central wavelength between the two adjacent longitudinal modes coincides with the peak wavelength of the wavelength tunable filter. As a result, it is considered that intervals between the peak position (optical output power peak wavelength) where the optical output power becomes maximum and the discontinuities are in different states in the right and the left, and a tolerance at the short wavelength side of which the interval is narrower becomes narrow. Namely, the distance between the peak wavelength in the characteristic of the filter itself and the wavelength where the mode hop occurs becomes small especially in the case of FIG. 5B as compared with in the case of FIG. 5D, therefore the laser oscillation becomes unstable when the oscillation wavelength is coincide with the peak wavelength of the filter.

In order to expand the interval between the optical output power peak wavelength and the discontinuity at the maximum, the point where the optical output power becomes maximum may be in an almost mid-point of the adjacent two discontinuities. And to realize this, in a state that the peak wavelength of the wavelength tunable filter coincides with the central wavelength between the two adjacent longitudinal modes, effective gains including asymmetric gains of the two longitudinal modes may be equivalent.

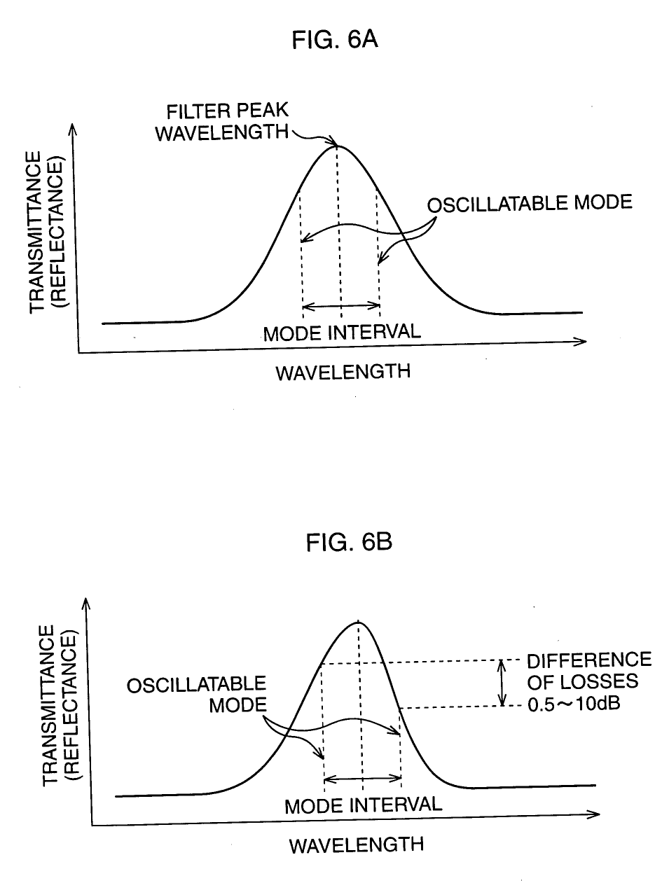

FIGS. 6 are characteristic charts showing relations between wavelengths and a transmittance or a reflectance in the wavelength tunable filter of the present invention, based on a comparison with the conventional wavelength tunable filter.

Since the conventional wavelength tunable filter has a symmetric filter characteristic with respect to the peak wavelength, a loss given to the long wavelength side and a loss given to the short wavelength side are approximately equal value as shown in FIG. 6A. Whereas, in the wavelength tunable filter of the present invention, a transmission spectrum or a reflection spectrum is asymmetric as shown in FIG. 6B, and a loss in a wavelength apart from the peak wavelength to the long wavelength side by a half value of the longitudinal mode interval is 0.5 dB to 10 dB larger than a loss in a wavelength apart from the peak wavelength to the short wavelength side by a half value of the longitudinal mode. Thereby, the effect by the asymmetric gain saturation is denied.

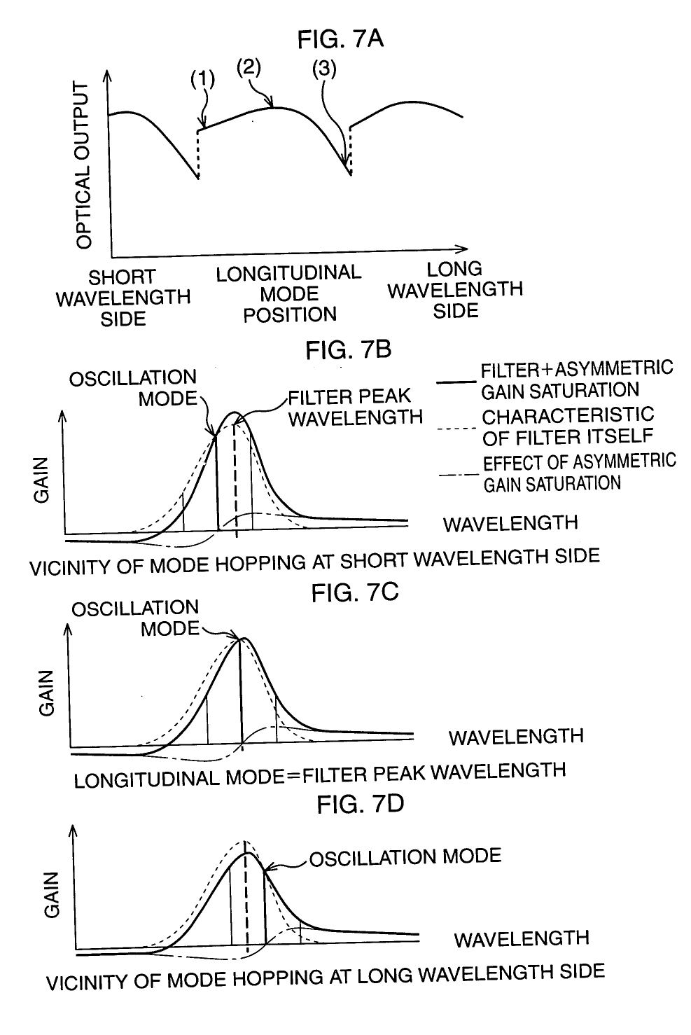

FIGS. 7 are characteristic charts showing relations between longitudinal mode positions and optical output powers when the wavelength tunable filter of the present invention having an asymmetric filter characteristic with respect to the peak wavelength is used.

FIG. 7A is a characteristic chart showing the relation between longitudinal mode positions and optical outputs, FIG. 7B is a characteristic chart showing a relation between a wavelength and a gain in the vicinity of a discontinuity at the short wavelength side shown in a code (1) of FIG. 7A, FIG. 7C is a characteristic chart showing a relation between a wavelength and a gain when the longitudinal mode shown in numeral (2) of FIG. 7A approximately coincides with the peak wavelength, and FIG. 7D is a characteristic chart showing a relation between a wavelength and a gain in the vicinity of a discontinuity at the long wavelength side shown in numeral (3) of FIG. 7A.

When the wavelength tunable filter having the asymmetric filter characteristic with respect to the peak wavelength, a point where a mode hopping occurs, i.e., a point where gains between the oscillation mode and the adjacent longitudinal mode are equivalent approximately agrees with a point where the central wavelength between the two adjacent longitudinal modes coincides with the peak wavelength of the wavelength tunable filter. As a result, as shown in FIG. 7A, the interval between the peak wavelength of the optical output power and the discontinuities are approximately equivalent in the right and the left, namely, a distance between the peak wavelength in a characteristic of a filter itself and an oscillation mode in the case of FIG. 7B is approximately equivalent to a distance in the case of FIG. 7D. Therefore, respective discontinuities of the right and the left can be maximally held off from the peak wavelength of the optical output. Due to the technique controlling the wavelength tunable filter so that the optical output power becomes maximum , this means the oscillation wavelength coincides the peak wavelength of the wavelength tunable filter , the highly stable control can be achieved.

### Specific Embodiments To Which Present Invention Is Applied

Hereinafter, based on the contents of above-described basic gist, specific embodiments to which the present invention is applied will be explained in detail with reference to drawings.

### First Embodiment

In this embodiment, a specific example of a wavelength tunable laser including a transmission-type wavelength tunable filter having an asymmetric filter characteristic.

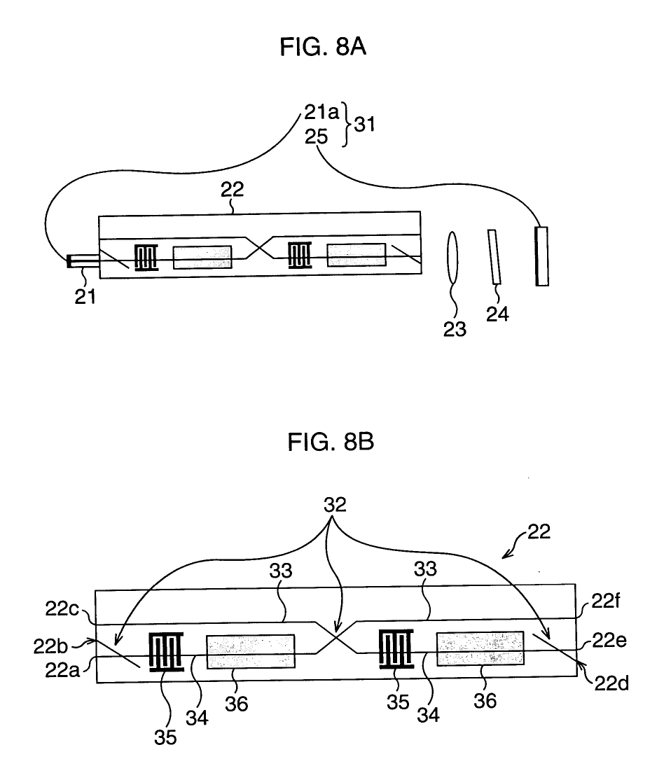

FIGS. 8 are schematic diagrams showing a principal structure of a transmission-type wavelength tunable laser according to the first embodiment.

As shown in FIG. 8A, the transmission-type wavelength tunable laser includes a semiconductor optical amplifier (SOA) 21 radiating a laser beam, an acousto-optic wavelength tunable filter (AOTF) 22 as being a transmission-type wavelength tunable filter having an asymmetric filter characteristic, a lens 23 condensing the laser beam, an etalon 24 as being an optical element having a cyclic transmissive wavelength, and a reflector 25.

The SOA 21 has an end surface 21a which is a cleavage surface functioning as a reflector, and a resonator 31 is formed between the end surface 21a and the reflector 25. As the SOA 21, for example, one of the SOAs using a bulk-structured waveguide as an active layer, the one using a MQW structured waveguide, or the one using a quantum-dot structure can be applied. Because an asymmetric gain saturation is generated in all the SOAs having respective structures described above. A Waveguide for controlling a phase is integrated in the SOA 21, therefore a longitudinal mode in the resonator 31 can be moved by injecting an electric current. As the etalon 24, for example, the one of which free spectrum range is 100 GHz is used.

The AOTF 22 is a waveguide-type filter as shown in FIG. 8B, and three input ports 22a, 22b, and 22c are provided in an input side and three output ports 22d, 22e, and 22f are provided in an output side respectively. Polarization beam splitters (PBS) 32 are arranged to an input end, an output end and a central part respectively. These input ports 22a, 22b, and 22c and these output ports 22d, 22e, and 22f and the PBSs 32 form two waveguides 33,34. In the AOTF 22, in order to set off the Doppler shift generated thereinside, the waveguides have a two-stage configuration.

On the basis of the input ports 22a, 22b and 22c, a comb electrode 35 in which electrode material is engaged in a shape like teeth of a comb and to which RF is applied, and a SAW guide 36 propagating a surface acoustic wave (SAW) generated from the comb electrode 35 are provided in a forward region and a backward region of the waveguide respectively.

In the AOTF 22, when a light is incident from the input port 22a, only a light having a specific wavelength which is decided by a RF frequency is radiated from the output port 22e. Therefore, the change of the RF frequency applied to the comb electrode 35 enables a wavelength tuning operation.

In the AOTF 22, an asymmetric filter characteristic is achieved as follows.

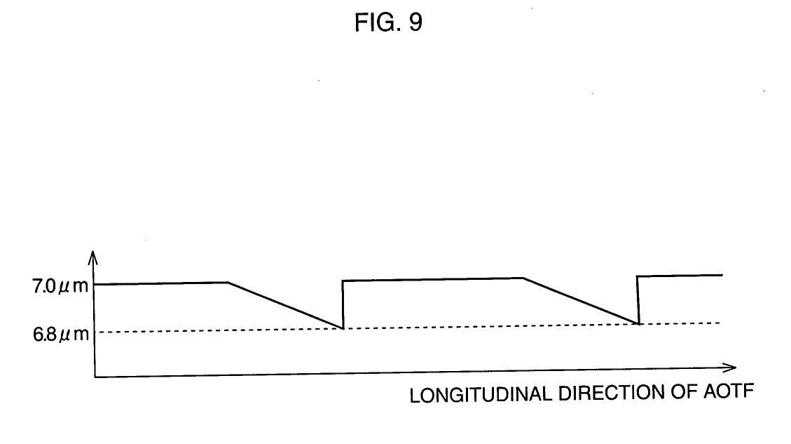

FIG. 9 is an explanatory chart showing an example realizing the asymmetric filter characteristic using the AOTF according to the present embodiment.

In the AOTF 22, in the region where the SAW guide 36 is provided at the waveguide 34, a distribution is given in a width of the waveguide 34 as shown in FIG. 9. In this case, the AOTF 22 is designed so that the width of the waveguide 34 is changed in a range of approximately 0.2 μm at the maximum. Accordingly, a difference of losses between a long-wavelength side and a short-wavelength side in a wavelength shifted by 50 GHz from a transmission peak wavelength, which corresponds to a half of the free spectrum range of the etalon 24 can be 1 dB. The difference of losses can be set to a desired value by changing the distribution of the width of the waveguide 34. This enables the control such that an oscillation wavelength of the laser is allowed to coincide with the peak wavelength of the filter in the AOTF 22 easily and accurately.

As described above, according to the present embodiment, a wavelength tunable laser whereby a stable laser radiation can be achieved at a desired oscillation wavelength, having a good noise characteristic can be actualized.

In the present embodiment, the AOTF 22 is used as a wavelength tunable filter having an asymmetric filter characteristic. The AOTF 22 is designed so that the width of the waveguide 34 is changeable with respect to an optical axis direction, therefore the transmissive spectrum is allowed to be asymmetric without difficulty, as a result, a reliable and stable laser radiation can be achieved.

In the present embodiment, the case that the transmission-type wavelength tunable laser having the asymmetric filter characteristic is achieved by using the AOTF 22 has been described, however, the invention is not limited to this embodiment. For example, by using a simple structured reflection-type AOTF, a reflection-type tunable laser having an asymmetric filter characteristic can also be achieved. In addtion, a wavelength tunable laser may be constituted not using the etalon 24.

### Second Embodiment

In this embodiment, a specific example of a wavelength tunable laser including a reflection-type wavelength tunable filter having an asymmetric filter characteristic will be described.

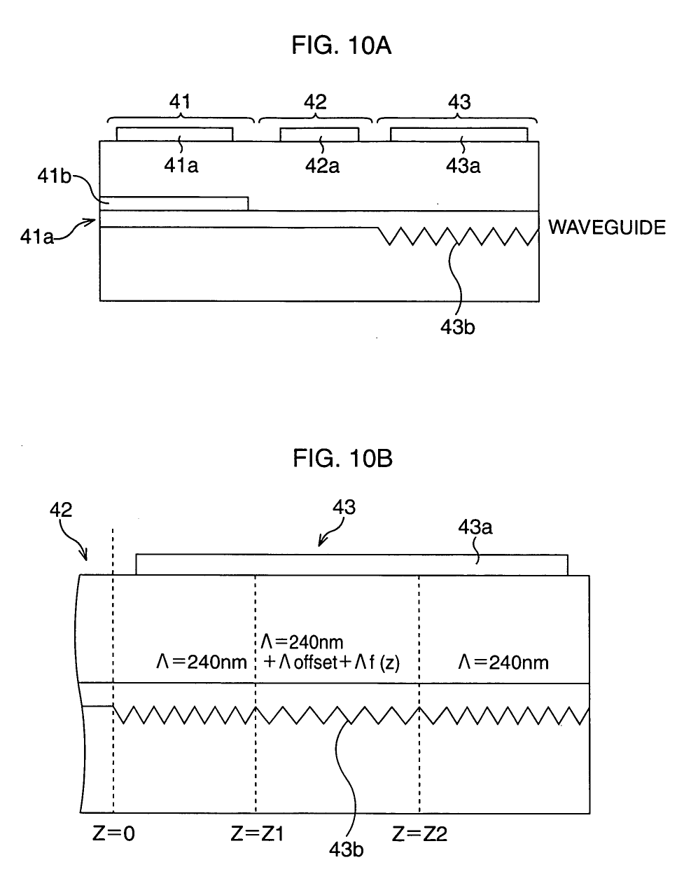

FIGS. 10 are schematic diagrams showing a principal structure of a reflection-type wavelength tunable laser according the second embodiment.

The reflection-type wavelength tunable laser is a so-called 3-electrode DBR (distribution Bragg reflection-type mirror) laser in which a filter characteristic of a DBR unit is asymmetric. The DBR unit can change a reflection wavelength thereof by injecting a electric current.

The wavelength tunable laser is constituted by including an active layer unit 41, a phase control unit 42, and the DBR unit 43 as shown in FIG. 10A. An electrode 41a is pattern-formed on an upper surface of the active layer unit 41, an electrode 42a is pattern-formed on an upper surface of the phase control unit 42 and an electrode 43a is pattern-formed on an upper surface of the DBR unit 43 respectively. The active layer unit 41 corresponds to a semiconductor optical amplifier (SOA) radiating a laser beam, and the DBR unit 43 corresponds to a reflection-type wavelength tunable filter. An element end surface 41a corresponding to an end portion of the SOA is a cleavage surface functioning as a reflector. A resonator 51 is formed between the element end surface 41a and the DBR unit 43. An active layer 41b is formed in the active layer unit 41 and a diffraction grating 43b is formed in the DBR unit 43 respectively.

By injecting the electric current to the DBR unit 43, a reflection peak wavelength can be changed. In addition, by injecting the electric current to the phase control unit 42, the position of a resonator longitudinal mode can be changed.

In the wavelength tunable laser of this embodiment, a difference from a conventional 3-electrode DBR laser is a shape of a reflection spectrum at the DBR unit 43. This can be achieved by changing a cycle of the diffraction grating 43b to an optical axis direction. In the conventional 3-electrode DBR laser, the cycle Λ of the diffraction grating 43b is constant, for example, 240 nm when the laser oscillates in 1.55 μm zone. Whereas, in this embodiment, when z denotes the position in the optical axis direction at the DBR unit 43 as shown in FIG. 10B, a distribution is given to the cycle of the diffraction grating as follows, for example.
Λ=240 nm+Λoffset+f(z):z1<z<z2, Λoffset+f(z)>0
Λ=240 nm :z<z1, z2<z

In this case, by designing f(z), Λoffset, a desired asymmetry can be obtained. Accordingly, a control such that an oscillation wavelength of the laser beam from the active layer unit 41 is allowed to coincide with a peak wavelength of a filter in the DBR unit 43 easily and accurately can be achieved.

As described above, according to the present embodiment, a wavelength tunable laser whereby a stable radiation of the laser beam at a desired oscillation wavelength can be possible, having a good noise characteristic can be realized.

In the present embodiment, a stable radiation of the laser beam with a simple structure can be possible by applying a reflection-type wavelength tunable laser, in this case, a 3-electrode DBR laser.

In the present embodiment, the case in which one DBR unit 43 is provided as a wavelength tunable filter is illustrated, however, this invention is not limited to this embodiment. For example, even if two or more DBR units are combined to be used as the wavelength tunable filter, it is suitable that the filter characteristic combining these characteristics of these DBR units may be designed to be asymmetric.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A wavelength tunable laser, comprising:
a resonator;
an optical amplifier provided inside said resonator, radiating a laser beam;
a wavelength tunable filter provided inside said resonator or provided as one part thereof, allowing an oscillation wavelength to be tunable; and
a phase controller controlling a phase of the laser beam resonating inside said resonator, wherein said wavelength tunable filter has an asymmetric filter characteristic and is designed so that a loss given to a long wavelength side with respect to a peak wavelength of the filter characteristic is larger than a loss given to a short wavelength side.

2. The wavelength tunable laser according to claim 1,
wherein said wavelength tunable filter is designed so that a loss in a wavelength apart from the peak wavelength of the filter to a long wavelength side by a half value of an oscillatable mode interval is from 0.5 dB to 10 dB larger than a loss in a wavelength apart to a short wavelength side by a half value of the oscillatable mode interval.

3. The wavelength tunable laser according to claim 1, further comprising:
an optical element having a cyclic transmissive wavelength inside said resonator.

4. The wavelength tunable laser according to claim 1,
wherein said resonator is constituted with two reflectors arranged to face each other, and
wherein said wavelength tunable filter is a transmission-type filter provided inside said resonator.

5. The wavelength tunable laser according to claim 1,
wherein said wavelength tunable filter is a reflection-type filter constituting said resonator with one reflector arranged to face said filter.

6. The wavelength tunable laser according to claim 1,
wherein said wavelength tunable filter is an waveguide-type acousto-optic wavelength tunable filter which allows a transmissive spectrum or a reflective spectrum to be asymmetric by changing a width of the waveguide with respect to an optical axis.

7. The wavelength tunable laser according to claim 5,
wherein said wavelength tunable filter is a distribution Bragg reflection-type mirror changing a reflection wavelength by injecting an electric current, which allows the reflection spectrum to be asymmetric by changing a cycle of a diffraction grating in the direction of the optical axis.

8. A method of controlling a wavelength tunable laser comprising:
a resonator;
an optical amplifier provided inside said resonator, radiating a laser beam;
a wavelength tunable filter provided inside said resonator or provided as one part thereof, allowing an oscillation wavelength to be tunable; and
a phase controller controlling a phase of the laser beam resonating inside said resonator,
wherein said wavelength tunable filter has an asymmetric filter characteristic and is designed so that a loss given to a long wavelength side with respect to a peak wavelength of the filter characteristic is larger than a loss given to a short wavelength side,
said method of controlling the wavelength tunable laser, comprising the step of:
controlling said wavelength tunable laser so that the oscillation wavelength of the laser is allowed to coincide with the peak wavelength of the filter in said wavelength tunable filter.

9. The method of controlling a wavelength tunable laser according to claim 8,
wherein said wavelength tunable filter is designed so that a loss in a wavelength apart from the peak wavelength of the filter characteristic to a long wavelength side by a half value of an oscillatable mode interval is from 0.5 dB to 10 dB larger than a loss in a wavelength apart to a short wavelength side by a half value of the oscillatable mode interval.

10. The method of controlling a wavelength tunable laser according to claim 8,
wherein said resonator includes an optical element having a cyclic transmissive wavelength thereinside.

11. The method of controlling a wavelength tunable laser according to claim 8,
wherein said resonator is constituted with two reflectors arranged to face each other, and
wherein said wavelength tunable filter is a transmission-type filter provided inside said resonator.

12. The method of controlling a wavelength tunable laser according to claim 8,
wherein said wavelength tunable filter is a reflection-type filter constituting said resonator with one reflector arranged to face said filter.

13. The method of controlling a wavelength tunable laser according to claim 8,
wherein said wavelength tunable filter is an waveguide-type acousto-optic wavelength tunable filter which allows a transmissive spectrum or a reflective spectrum to be asymmetric by changing a width of the waveguide with respect to an optical axis.

14. The method of controlling a wavelength tunable laser according to claim 13,
wherein said wavelength tunable filter is a distribution Bragg reflection-type mirror changing a reflection wavelength by injecting an electric current which allows the reflection spectrum to be asymmetric by changing a cycle of a diffraction grating in the direction of the optical axis.
